(19) United States
(12) Patent Application Publication
(10) Pub. No.: US 2026/0148668 A1
(43) Pub. Date: May 28, 2026

(54) ELECTRONIC DEVICE FOR DISPLAYING 3D CONTENT AND CONTROL METHOD THEREOF

(71) Applicant: Samsung Electronics Co., Ltd., Suwon-si (KR)

(72) Inventors: Jieun KIM, Suwon-si (KR); Joayoung LEE, Suwon-si (KR)

(21) Appl. No.: 19/453,466

(22) Filed: Jan. 20, 2026

Related U.S. Application Data
(63) Continuation of application No. PCT/KR2024/010728, filed on Jul. 24, 2024.

(30) Foreign Application Priority Data
Jul. 24, 2023 (KR) 10-2023-0095920
Nov. 22, 2023 (KR) 10-2023-0163248

(51) Int. Cl. G09G 3/00; G06F 3/01

(52) U.S. Cl. CPC G09G 3/003; G06F 3/013; G09G 2320/06; G09G 2354/00

(57) ABSTRACT

An electronic device is provided. The electronic device includes a display configured to display a left-eye image and a right-eye image, memory, including one or more storage media, storing instructions, and a processor electrically connected to the display and the memory, wherein the instructions, when executed by the processor individually or collectively, cause the electronic device to control the display to display a plurality of two-dimensional (2D) contents including content displayable in three-dimensional (3D) through the left-eye image and the right-eye image without parallax, identify, based on a user input, that the content displayable in 3D among the plurality of 2D contents is disposed within a set area, and control the display to display the content disposed within the set area in 3D.

### CROSS-REFERENCE TO RELATED APPLICATION(S

This application is a continuation application, claiming priority under 35 U.S.C. § 365(c), of an International application No. PCT/KR2024/010728, filed on July 24, 2024, which is based on and claims the benefit of a Korean patent application number 10-2023-0095920, filed on July 24, 2023, in the Korean Intellectual Property Office, and of a Korean patent application number 10-2023-0163248, filed on November 22, 2023, in the Korean Intellectual Property Office, the disclosure of each of which is incorporated by reference herein in its entirety.

### BACKGROUND

### Field

The disclosure relates to an electronic device displaying three-dimensional (3D) content and a control method thereof.

### Description of Related Art

More and more services and additional functions are being provided through electronic devices, e.g., portable electronic devices such as smartphones. To meet the needs of various users and raise the usefulness/utility of electronic devices, communication service carriers or electronic device manufacturers are competitively developing electronic devices to provide various functions and differentiate themselves from other companies. Accordingly, various functions that are provided through electronic devices are evolving more and more.

Further, the electronic device provides various graphic user interfaces (GUIs) for interaction with the user through the display.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device displaying 3D content and a control method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a display configured to display a left-eye image and a right-eye image, memory, including one or more storage media, storing instructions, and one or more processors electrically connected with the display and the memory, wherein the instructions, when executed by the one or more processors individually or collectively, cause the electronic device to control the display to display a plurality of two-dimensional (2D) contents including content displayable in three-dimensional (3D) through the left-eye image and the right-eye image without parallax, identify, based on a user input, that the content displayable in 3D among the plurality of 2D contents is disposed within a set area, and control the display to display the content disposed within the set area in 3D.

According to an embodiment, the memory stores instructions that, when executed by the one or more processors, cause the electronic device to control the display to display a left-eye image and a right-eye image of a screen including a plurality of two-dimensional (2D) contents including 2D content corresponding to 3D content.

According to an embodiment, the memory stores instructions that, when executed by the one or more processors, cause the electronic device to identify that the 2D content corresponding to the 3D content among the plurality of 2D contents is disposed in a set area based on a user input for controlling the screen.

According to an embodiment, the memory stores instructions that, when executed by the one or more processors, cause the electronic device to control the display to display the 2D content as 3D content.

In accordance with another aspect of the disclosure, a control method of an electronic device is provided. The control method includes displaying a plurality of two-dimensional (2D) contents including corresponding content displayable in three-dimensional (3D) through a left-eye image and a right-eye image without parallax, identifying, based on a user input, that the content displayable in 3D among the plurality of 2D contents is disposed within a set area, and displaying the content disposed within the set area in 3D.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include displaying a plurality of two-dimensional (2D) contents including corresponding content displayable in three-dimensional (3D) through a left-eye image and a right-eye image without parallax, identifying, based on a user input, that the content displayable in 3D among the plurality of 2D contents is disposed within a set area, and displaying the content disposed within the set area in 3D.

According to an embodiment, the operations include identifying a position of the user's both eyes obtained through the at least one sensor.

According to an embodiment, the operations include identifying that 2D content including depth information among the plurality of 2D contents is disposed in a set area based on a scroll input of the screen.

According to an embodiment, the operations include controlling the display to display the 2D content as 3D content based on the position of the both eyes and the depth information.

According to an embodiment, an electronic device includes at least one sensor for identifying a position of a user's eyes, a display, and at least one processor electrically connected with the at least one sensor and the display.

According to an embodiment, the memory stores instructions that, when executed by the processor, cause the electronic device to control the display to display a screen including a first 2D content and a second 2D content corresponding to 3D content.

According to an embodiment, the memory stores instructions that, when executed by the processor, cause the electronic device to identify that the second 2D content is disposed in a set area of the display based on a user input for controlling the screen.

According to an embodiment, the memory stores instructions that, when executed by the processor, cause the electronic device to display the 3D content as an upper layer of the second 2D content.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a flowchart illustrating a 3D content display operation of an electronic device according to an embodiment of the disclosure;

FIG. 3A is a view illustrating a screen including a plurality of 2D contents of an electronic device according to an embodiment of the disclosure;

FIG. 3B is a view illustrating an operation of changing 2D content including depth information among a plurality of 2D contents to a 3D mode in an electronic device according to an embodiment of the disclosure;

FIG. 3C is a view illustrating an operation of displaying 3D content according to a scroll input of an electronic device according to an embodiment of the disclosure;

FIG. 3D is a view illustrating an operation of displaying 3D content according to a scroll input of an electronic device according to an embodiment of the disclosure;

FIG. 4A is a view illustrating a 3D content display area of an electronic device according to an embodiment of the disclosure;

FIG. 4B is a view illustrating an operation of displaying 3D content based on a 3D content display area of an electronic device according to an embodiment of the disclosure;

FIG. 5A is a view illustrating a structure for providing 3D content of an electronic device according to an embodiment of the disclosure;

FIG. 5B is a view illustrating a structure for providing 3D content of an electronic device according to an embodiment of the disclosure;

FIG. 6A is a view illustrating an operation of displaying 3D content based on a scroll input on a screen including 2D content of an electronic device according to an embodiment of the disclosure;

FIG. 6B is a view illustrating an operation of displaying 3D content of an electronic device according to an embodiment of the disclosure;

FIG. 7A is a view illustrating a screen including 2D content including depth information of an electronic device according to an embodiment of the disclosure;

FIG. 7B is a view illustrating an operation of displaying 3D content based on a scroll input of an electronic device according to an embodiment of the disclosure;

FIG. 8 is a view illustrating a display operation based on content characteristics of an electronic device according to an embodiment of the disclosure;

FIG. 9A is a view illustrating a 3D content display operation in an application screen of an electronic device according to an embodiment of the disclosure;

FIG. 9B is a view illustrating a 3D content display position adjustment operation in an application screen of an electronic device according to an embodiment of the disclosure;

FIG. 10A is a view illustrating a 3D content display operation in an application screen of an electronic device according to an embodiment of the disclosure;

FIG. 10B is a view illustrating a 2D content display position adjustment operation according to 3D content display in an application screen of an electronic device according to an embodiment of the disclosure;

FIG. 11 is a view illustrating a 3D content display operation of a foldable device according to an embodiment of the disclosure;

FIG. 12A is a view illustrating an embodiment in which 3D advertisement content is included in an application screen of an electronic device according to an embodiment of the disclosure;

FIG. 12B is a view illustrating an embodiment in which 3D advertisement content is included in an application screen of an electronic device according to an embodiment of the disclosure;

FIG. 13 is a view illustrating an operation of displaying 3D content based on a user input of an electronic device according to an embodiment of the disclosure;

FIG. 14A is a view illustrating a 3D content display operation of an electronic device according to an embodiment of the disclosure;

FIG. 14B is a view illustrating an animation effect display operation of 3D content of an electronic device according to an embodiment of the disclosure;

FIG. 14C is a view illustrating an operation of displaying a 2D content screen after displaying an animation effect of 3D content of an electronic device according to an embodiment of the disclosure; and

FIG. 14D is a view illustrating a selected 3D content display operation of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

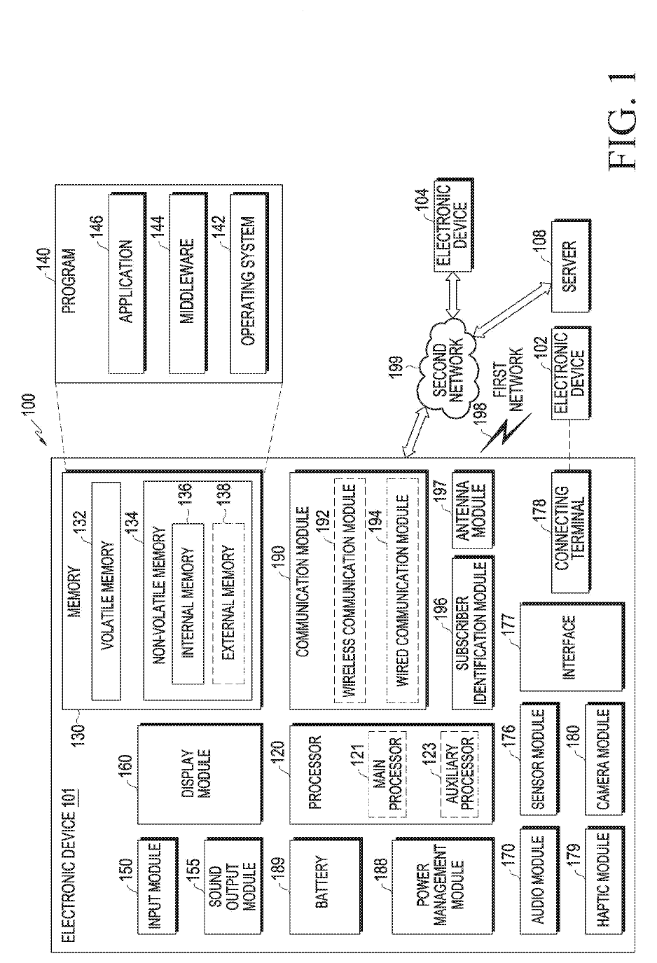

FIG. 1 is a block diagram illustrating an electronic device in a network environment according to an embodiment of the disclosure.

Referring to FIG. 1, an electronic device 101 in a network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth^{TM}, wireless-fidelity (Wi-Fi) direct, or infrared data association (IrDA)) or a second network 199 (e.g., a long-range communication network, such as a legacy cellular network, a fifth-generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

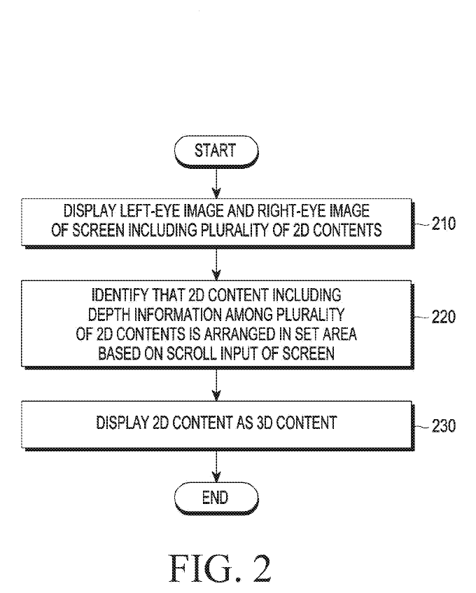

FIG. 2 is a flowchart illustrating a 3D content display operation of an electronic device according to an embodiment of the disclosure.

Referring to FIG. 2, in operation 210, an electronic device (e.g., the electronic device 101 of FIG. 1 or the processor 120 of FIG. 1) may display a left-eye image and a right-eye image of a screen including a plurality of 2D contents. According to an embodiment, the plurality of 2D contents may include content displayable in 3D.

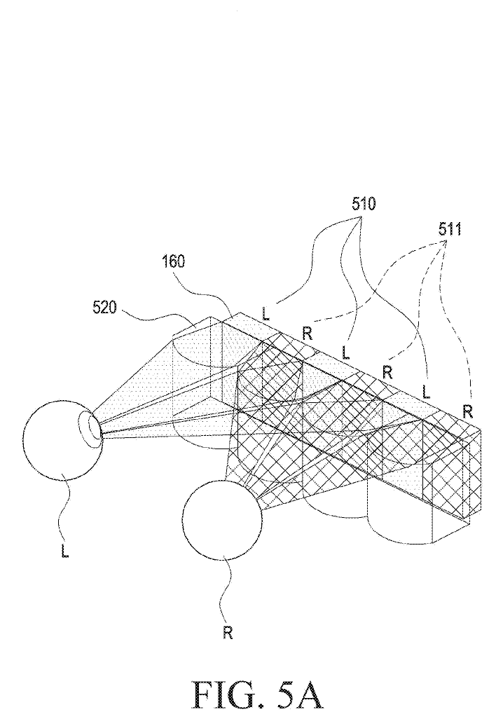

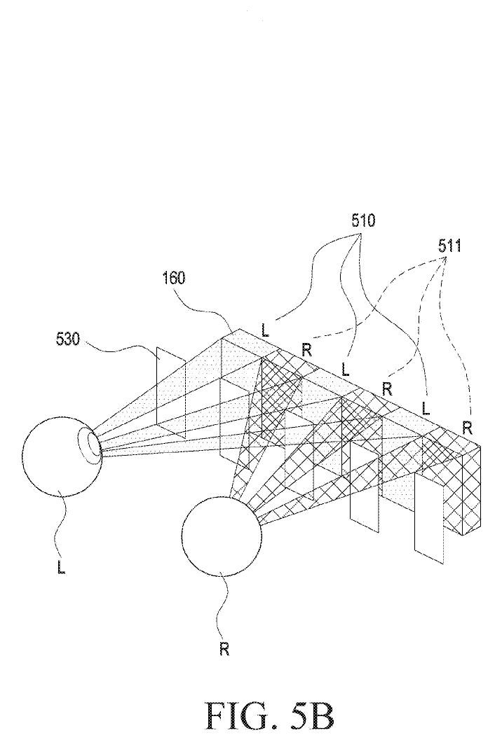

According to an embodiment, the electronic device may control a display (e.g., the display module 160 of FIG. 1) so that a plurality of left-eye images and a plurality of right-eye images are alternately displayed in a left-right direction. According to an embodiment, the operation of displaying the left-eye image and the right-eye image is described in more detail with reference to FIGS. 5A and 5B below.

According to an embodiment, the electronic device may display a plurality of 2D contents with depth information of 0. For example, since 3D content is made to appear three-dimensional by implementing depth information through binocular disparity by the left-eye image and the right-eye image, the electronic device may display the left-eye image and the right-eye image so that depth information becomes 0 for 2D content. According to an embodiment, the electronic device may display a plurality of 2D contents through the left-eye image and the right-eye image without parallax.

According to an embodiment, in operation 220, the electronic device may identify that 2D content including depth information (or content displayable in 3D) among the plurality of 2D contents is disposed in a set area based on a user input for controlling the screen. For example, the user input for controlling the screen may include at least one of a scroll input, a swipe input, a navigating input method, or pinch in/out. In the disclosure, the scroll input to the screen is not limited thereto, and at least one of a swipe input, a navigating input method, or pinch in/out may be applied.

According to an embodiment, the electronic device may switch a screen including only 2D content to a 3D mode for displaying 3D content. For example, if the screen includes 2D content including depth information, the electronic device may automatically switch to a 3D mode, or switch to the 3D mode based on receiving a user input selecting an icon for switching to the 3D mode or a gesture input for switching to the 3D mode.

According to an embodiment, in the 3D mode, the electronic device may display that at least one 2D content including depth information among the 2D content included in the screen is 3D content. For example, shadow information such as a shadow may be displayed on at least one 2D content including depth information to indicate that it is 3D content.

According to an embodiment, it may be identified that 2D content including depth information is disposed in a set area based on a scroll input in the 3D mode. For example, the scroll input may include not only a scroll operation within a page but also a drag, swipe operation, or flick operation for screen movement or switching.

According to an embodiment, the electronic device may further include a film disposed on at least a partial area on the display to provide 3D content by transmitting the left-eye image and the right-eye image. For example, the film may include at least one of a lenticular lens or a parallax barrier. The film may be for separating the direction of light of the image so that the left-eye image is seen by the user's left eye and the right-eye image is seen by the user's right eye.

According to an embodiment, the structure of the film disposed on the display is described in more detail with reference to FIGS. 5A and 5B below.

According to an embodiment, the film may be disposed on the entire area of the display or may be disposed on a partial area of the display.

According to an embodiment, when the film is disposed on the entire area of the display, the set area may be an area set for displaying 3D content. According to an embodiment, when the film is disposed on a partial area of the display, the set area may be the partial area where the film is disposed on the display.

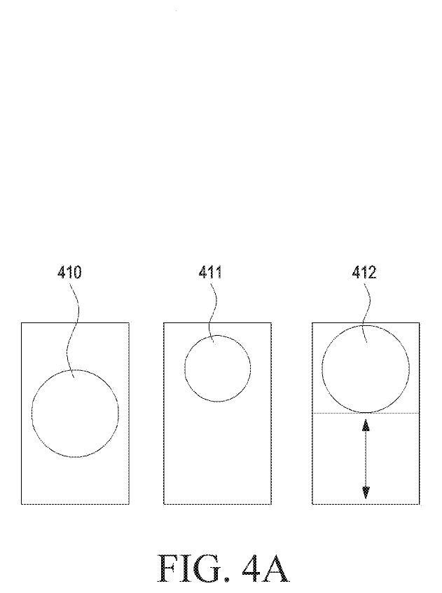

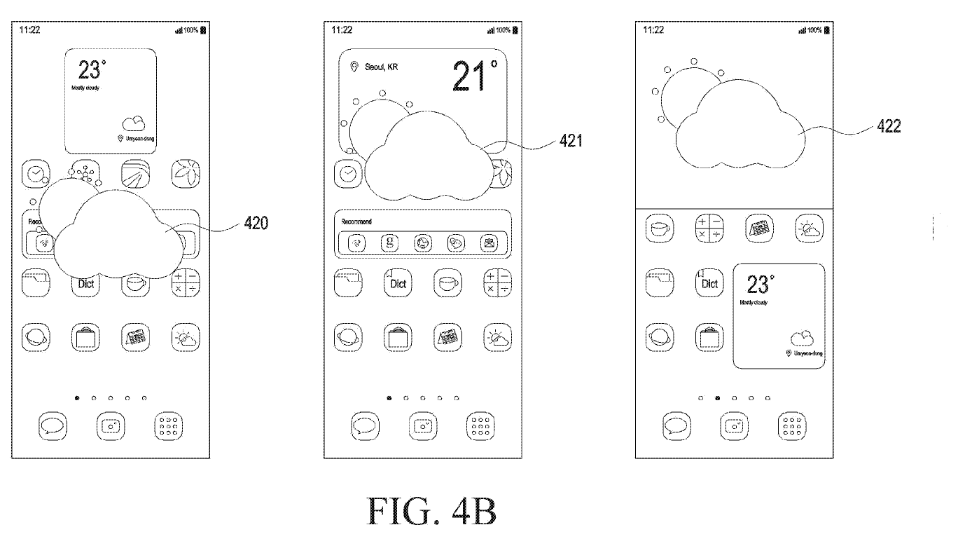

According to an embodiment, various examples of the set area is described with reference to FIG. 4A below.

According to an embodiment, in operation 230, the electronic device may display 2D content as 3D content. According to an embodiment, the electronic device may display 2D content as 3D content based on at least one of the position of both eyes or depth information. According to an embodiment, the electronic device may display content disposed within the set area in 3D.

According to an embodiment, the electronic device may identify the position of the user's both eyes obtained through at least one sensor (e.g., the sensor module 176 of FIG. 1). For example, the electronic device may identify the position of the user's both eyes through a camera (e.g., RGB sensor) for obtaining images of both eyes and/or a depth sensor (e.g., ToF sensor or Lidar sensor) for obtaining depth information.

According to an embodiment, the electronic device may obtain binocular disparity based on the position of the user's both eyes. The binocular disparity may be the distance between the user's right eye and left eye.

According to an embodiment, in addition to identifying the position of the user's both eyes through at least one sensor, the electronic device may identify the position of both eyes through user facial recognition or identify the position of both eyes through detection of body portions other than the eyes.

According to an embodiment, the electronic device may display 2D content as 3D content by displaying the left-eye image and the right-eye image to have stereoscopic effect corresponding to the depth information based on the binocular disparity.

According to an embodiment, the electronic device may display 3D content with an increased size compared to the 2D content. For example, the electronic device may increase the size of content displayed in 3D to overlay the 3D content on surrounding 2D content.

According to an embodiment, the electronic device may display the 3D content at a depth closer than the depth where 2D content is displayed to make it appear relatively larger than other 2D content.

According to an embodiment, based on the 3D content including information about animation effects (e.g., size change, rotation, position movement, tilt, morphing, perspective effect, volume effect), the electronic device may display 3D content including animation effects.

According to an embodiment, in the 3D mode, the electronic device may provide different stereoscopic effects based on characteristics of content included in the screen. For example, among 2D content included in the screen, 2D content including depth information may provide a stereoscopic effect (e.g., (+) stereoscopic effect) of protruding from the display based on the depth information.

According to an embodiment, the electronic device may display 2D content not including depth information as 2D content without stereoscopic effect with depth of 0 on the display. According to an embodiment, among 2D content not including depth information, the electronic device may display 2D content including information (e.g., icons, images, or text related to services or functions) with depth of 0 on the display, and 2D content without information (e.g., background screen providing decorative effects) may provide a stereoscopic effect (e.g., (-) stereoscopic effect) as if receding behind the display.

According to an embodiment, when a plurality of 2D contents including depth information are included in a set area capable of displaying 3D content of the screen, the electronic device may sequentially display the plurality of 2D contents as 3D content or display all of the plurality of 2D contents as 3D content.

According to an embodiment, when a plurality of 2D contents including depth information are included in a set area capable of displaying 3D content, the electronic device may preferentially display 2D content positioned at the top of the screen as 3D content.

According to an embodiment, when a plurality of 2D contents including depth information are included in a set area capable of displaying 3D content, the electronic device may preferentially display 2D content with high preference as 3D content based on user preference. For example, the preference may be based on selection as interested content, filtering keywords, and/or number of times displayed.

According to an embodiment, when a plurality of 2D contents including depth information are included in a set area capable of displaying 3D content, the electronic device may preferentially display 2D content with high urgency and/or importance, such as notification occurrence, as 3D content.

According to an embodiment, the electronic device may sequentially display a plurality of 2D contents including depth information as 3D content.

For example, the electronic device may change 3D content to 2D content based on identifying that the 3D content is outside the set area based on a scroll input received after displaying the 3D content. According to an embodiment, the electronic device may display a second 2D content as a second 3D content based on identifying that the second 2D content including depth information is disposed in the set area.

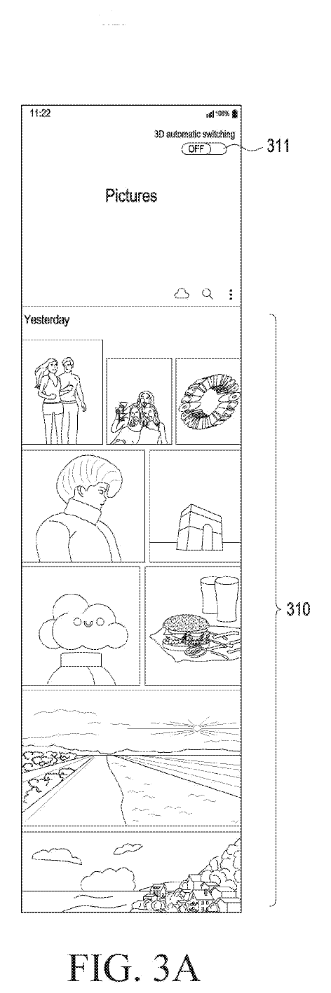

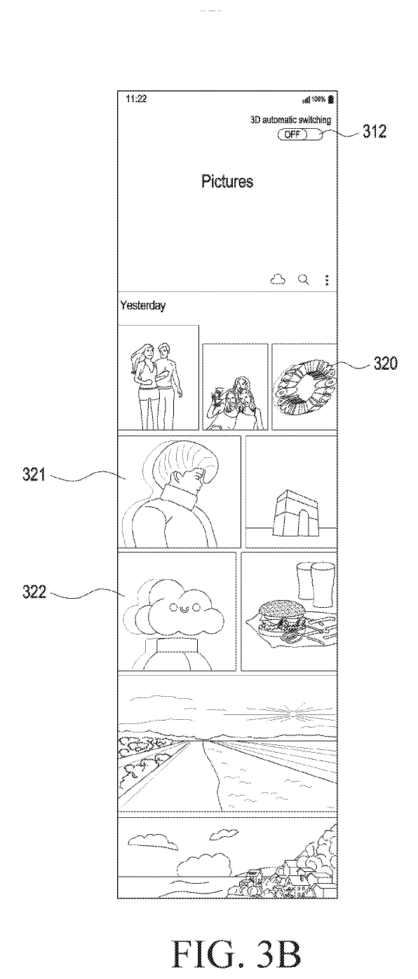

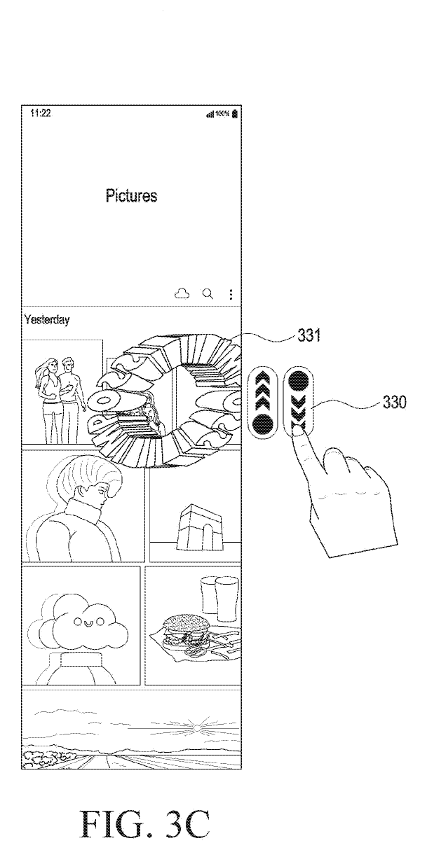

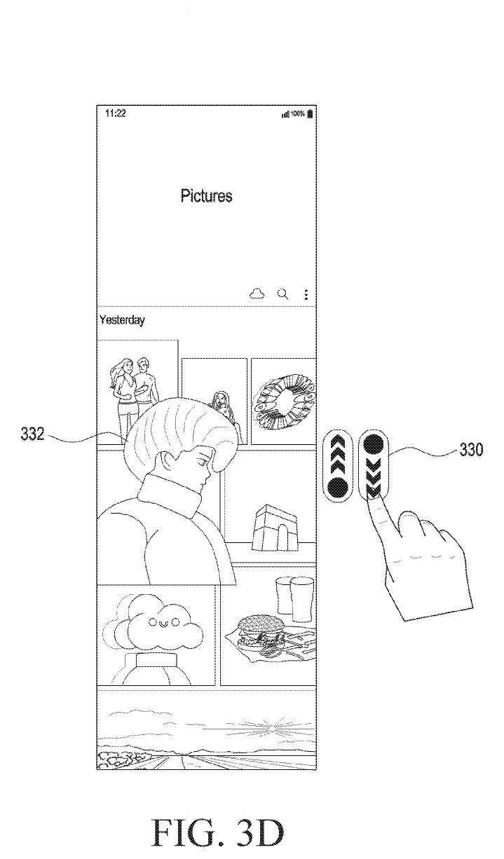

According to an embodiment, the operation of sequentially displaying as 3D content based on the scroll input is described in more detail with reference to FIGS. 3A to 3D below.

According to an embodiment, when a plurality of 2D contents including depth information are included in a set area capable of displaying 3D content, the electronic device may display each of the plurality of 2D contents including depth information included in the screen as a plurality of 3D contents based on a scroll input.

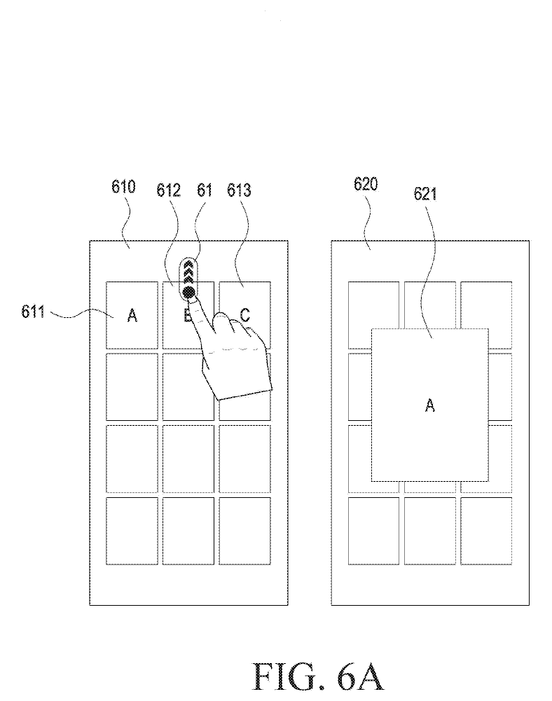

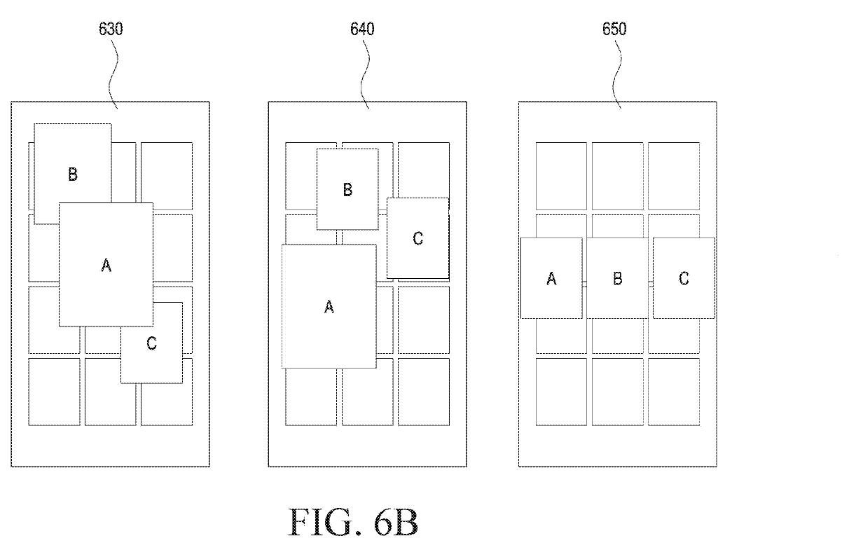

According to an embodiment, an example in which a plurality of 3D contents are displayed on the screen is described in more detail with reference to FIGS. 6A and 6B below.

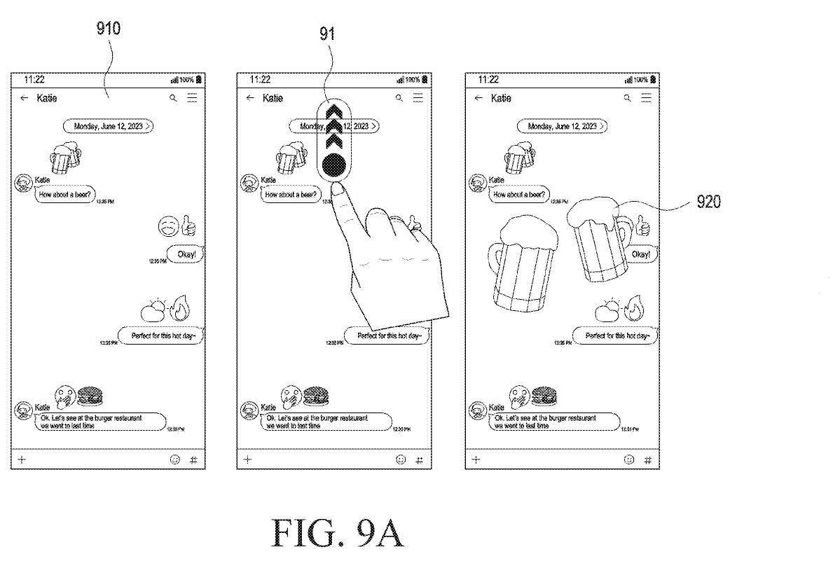

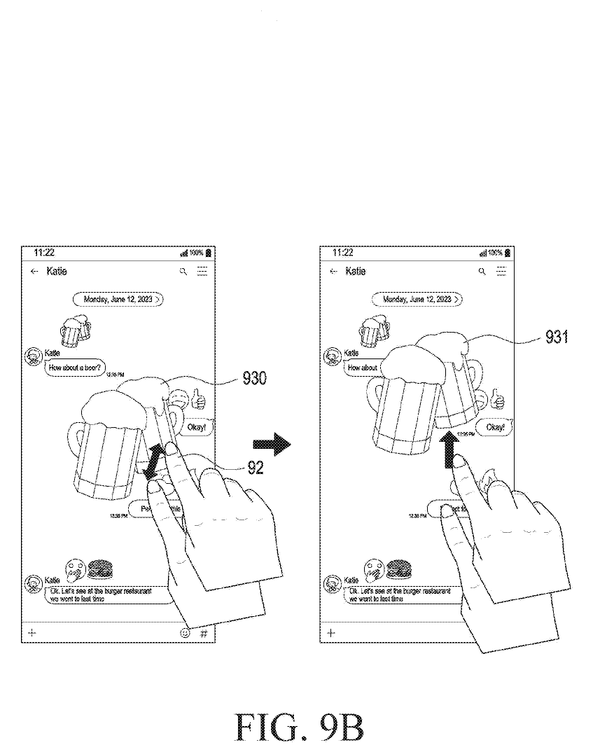

According to an embodiment, the electronic device may control the display to display the size-increased 3D content at a position different from the position of the scroll input. As such, when the position of the scroll input and the area where the 3D content is displayed overlap, instability such as the 3D content breaking may be prevented. According to an embodiment, the operation of changing the position of 3D content based on the position of the scroll input is described in more detail with reference to FIGS. 9A and 9B below.

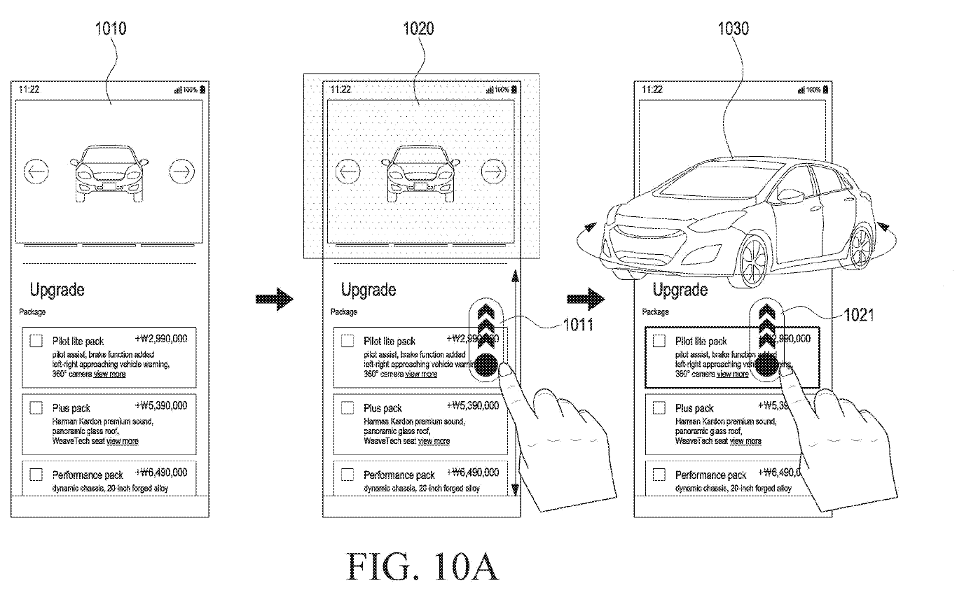

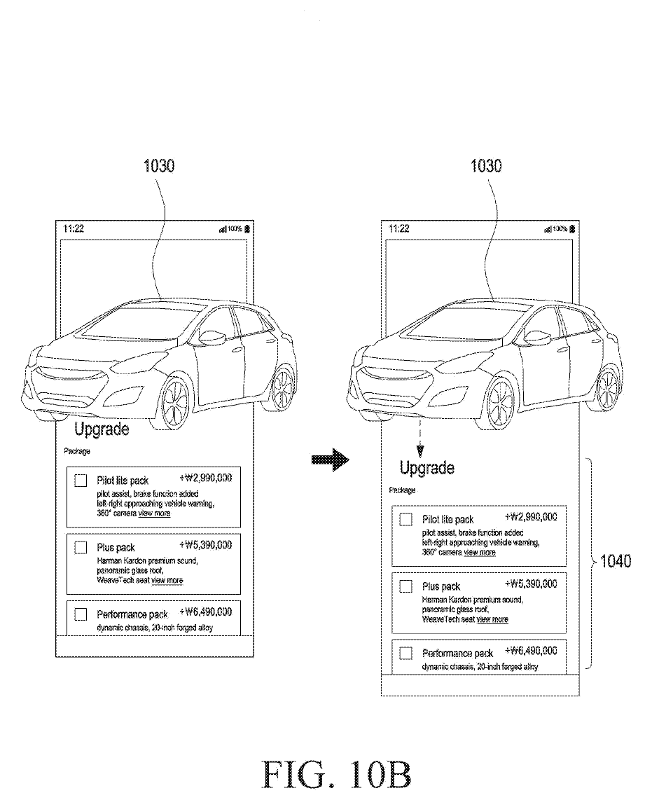

According to an embodiment, the electronic device may change a position of 2D content overlapping the size-increased 3D content. For example, when 2D content such as text that is a description of 3D content is obscured by 3D content, the electronic device may change the position of the 2D content so that the 2D content is not obscured by the 3D content. According to an embodiment, the position of the changed content may vary according to the position of both eyes. According to an embodiment, the operation of changing the position of 2D content obscured by 3D content is described with reference to FIGS. 10A and 10B below.

According to an embodiment, the electronic device may display a 3D advertisement in the set area based on absence of a scroll input for a set period after the 3D content is displayed in the set area.

According to an embodiment, the electronic device may display 3D content in the set area based on receiving a scroll input after displaying the 3D advertisement in the set area.

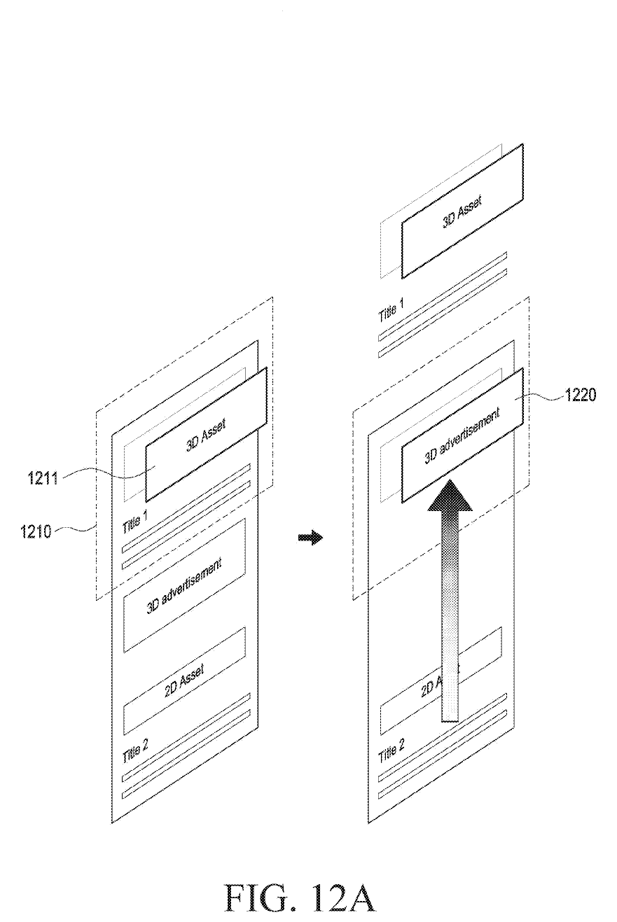

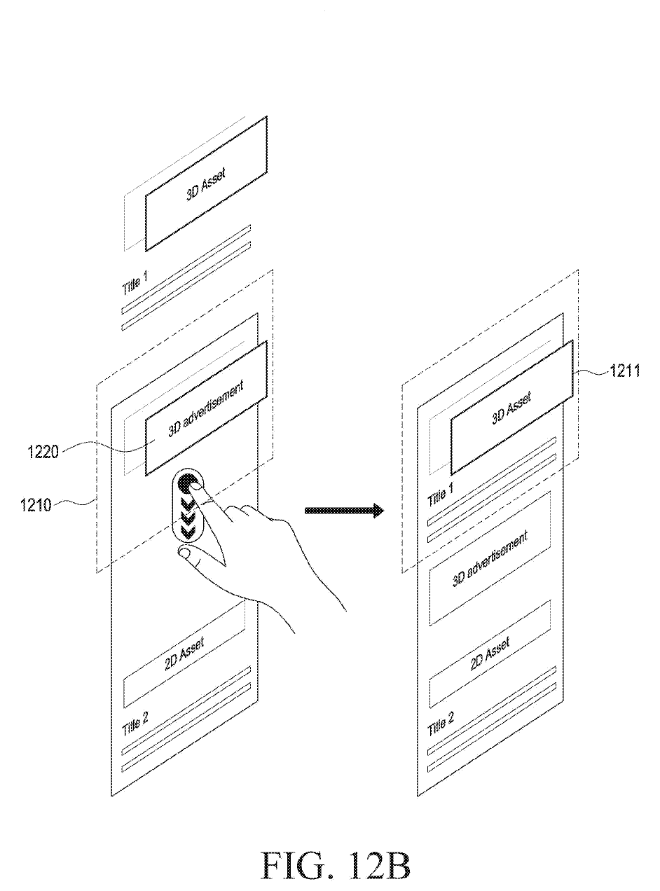

According to an embodiment, an embodiment in which 3D advertisement is included in the screen is described in more detail with reference to FIGS. 12A and 12B below.

As such, the user may efficiently identify 2D information and simultaneously experience 3D information with various attributes through just a scroll input with one hand without complex interaction.

FIG. 3A is a view illustrating a screen including a plurality of 2D contents of an electronic device according to an embodiment of the disclosure.

Referring to FIG. 3A, an electronic device (e.g., the electronic device 101 of FIG. 1 or the processor 120 of FIG. 1) may display a screen including a plurality of 2D contents 310. For example, the plurality of 2D contents 310 may include 2D content not including depth information and 2D content including depth information.

According to an embodiment, the screen may be a home screen or an execution screen of an application such as a messenger, photo album, or browser.

According to an embodiment, the plurality of 2D contents 310 may include 2D content and 2D content corresponding to 3D content.

According to an embodiment, the electronic device may display a button 311 for 3D automatic switching when the screen includes 2D content corresponding to 3D content. For example, the button 311 for 3D automatic switching is for switching a screen including only 2D content to a 3D mode for displaying 3D content based on a user input.

In FIG. 3A, since it is before switching to the 3D mode, the button 311 for 3D automatic switching may be in an OFF state.

FIG. 3B is a view illustrating an operation of changing 2D content including depth information among a plurality of 2D contents to a 3D mode in an electronic device according to an embodiment of the disclosure.

Referring to FIG. 3B, the electronic device may identify that 2D content including depth information is included among a plurality of 2D contents included in the screen.

According to an embodiment, the electronic device may switch a screen including only 2D content to a 3D mode for displaying 3D content. For example, if the screen includes 2D content including depth information, the electronic device may automatically switch to a 3D mode, or switch to the 3D mode based on receiving a user input selecting a button 312 for switching to the 3D mode or a gesture input for switching to the 3D mode.

According to an embodiment, in the 3D mode, the electronic device may display that at least one 2D content 320, 321, 322 including depth information among the 2D content included in the screen is 3D content. For example, shadow information such as a shadow may be displayed on at least one 2D content 320, 321, 322 including depth information to indicate that it is 3D content.

In FIG. 3B, since it is in a state switched to the 3D mode, the button 312 for 3D automatic switching may be in an ON state.

FIG. 3C is a view illustrating an operation of displaying 3D content according to a scroll input of an electronic device according to an embodiment of the disclosure.

Referring to FIG. 3C, the electronic device may display at least one 2D content satisfying a set condition among at least one 2D content including depth information as 3D content 331 based on a scroll input 330.

For example, the electronic device may display 2D content disposed in a set area among at least one 2D content including depth information as 3D content 331 based on a scroll input 330 in a state switched to the 3D mode. According to an embodiment, the set area may be an area set for displaying 3D content and may be a partial area where a film is disposed on the display. For example, the set area may include at least one of a top area of the screen, a middle area of the screen, an area where the user's gaze stays, or an area set by the user among partial areas where a film is disposed on the display.

For example, the electronic device may display 2D content positioned at the top or 2D content based on user preference among a plurality of 2D contents including depth information disposed in the set area as 3D content 331.

According to an embodiment, the electronic device may display the 3D content 331 to provide a stereoscopic effect protruding from the display based on depth information. According to an embodiment, the electronic device may display 3D content 331 with the same or increased size to overlay on surrounding 2D content.

According to an embodiment, based on the 3D content including information about animation effects (e.g., size change, rotation, position movement, tilt, morphing, volume effect), the electronic device may display 3D content including animation effects.

According to an embodiment, in the 3D mode, the electronic device may provide different stereoscopic effects based on characteristics of content included in the screen. For example, among 2D content included in the screen, 2D content including depth information may provide a stereoscopic effect (e.g., (+) stereoscopic effect) of protruding from the display based on the depth information. For example, the electronic device may stereoscopically display 3D content so that the appearance of 3D content corresponding to the direction is displayed according to the direction in which the user views the 3D content.

According to an embodiment, in a state in which a plurality of 2D contents are displayed at a first depth, the electronic device may display 2D content not including depth information among the plurality of 2D contents at at least one of the first depth or a second depth farther than the first depth.

According to an embodiment, the electronic device may display 2D content not including depth information as 2D content without stereoscopic effect with depth of 0 on the display. According to an embodiment, among 2D content not including depth information, the electronic device may display 2D content including information (e.g., icons, images, or text related to services or functions) with depth of 0 on the display, and 2D content without information (e.g., background screen providing decorative effects) may provide a stereoscopic effect (e.g., (-) stereoscopic effect) as if receding behind the display.

FIG. 3D is a view illustrating an operation of displaying 3D content according to a scroll input of an electronic device according to an embodiment of the disclosure.

Referring to FIG. 3D, the electronic device may change 3D content to 2D content 320 based on identifying that the 3D content is outside the set area based on a scroll input 330 received after displaying the 3D content. According to an embodiment, the electronic device may display a second 2D content as a second 3D content 332 based on identifying that the second 2D content including depth information is disposed in the set area.

As such, 3D content included in the screen may be identified based on the scroll input.

According to an embodiment, although FIGS. 3C and 3D illustrate displaying 3D content in an area where 2D content is located, 3D content may be displayed in a set area as illustrated in FIGS. 4A and 4B below.

FIG. 4A is a view illustrating a 3D content display area of an electronic device according to an embodiment of the disclosure.

FIG. 4B is a view illustrating an operation of displaying 3D content based on a 3D content display area of an electronic device according to an embodiment of the disclosure.

Referring to FIG. 4A, a film such as a lenticular lens or parallax barrier may be disposed on the full area or partial area (half) of the display.

According to an embodiment, the electronic device may display 3D content in a central area 410 among areas where the film is disposed. For example, as illustrated in FIG. 4B, even when 2D content including depth information (e.g., 2D content included in a weather widget) is disposed in the top area, the electronic device may display 3D content 420 in the central area.

According to an embodiment, the electronic device may also display 3D content in an area 411 where 2D content including depth information is located among areas where the film is disposed. For example, as illustrated in FIG. 4B, the electronic device may display 3D content 421 in the top area where 2D content including depth information (e.g., 2D content included in a weather widget) is located.

According to an embodiment, when the film is disposed only on a partial area of the display, the electronic device may display 3D content for 2D content positioned at the top or having the highest user preference among 2D content including depth information included in an area where the film is not disposed in the area 412 where the film is disposed. For example, as illustrated in FIG. 4B, 3D content 422 for 2D content including depth information (e.g., 2D content included in a weather widget) included in an area where the film is not disposed may be displayed in the area where the film is disposed.

FIG. 5A is a view illustrating a structure for providing 3D content of an electronic device according to an embodiment of the disclosure. For example, FIG. 5A illustrates a structure including a lenticular lens.

Referring to FIG. 5A, the electronic device may alternately arrange a left-eye image 510 and a right-eye image 511 to display on a display 160 (e.g., the display module 160 of FIG. 1).

According to an embodiment, the electronic device may include a lenticular lens 520 on the display 160. For example, the lenticular lens 520 is one of glass-free, glassless, naked eye stereoscopic 3D technologies, for changing patterns according to angles or representing stereoscopic effect, and may be an arrangement of thin and long cylindrical convex lenses. The direction of light progression of the image may be divided into left and right through the refractive index of the cylindrical convex lenses.

Although FIG. 5A illustrates vertically long left-eye images and right-eye images alternately disposed in a left-right direction, according to an embodiment, the left-eye images and right-eye images may be alternately disposed diagonally.

According to an embodiment, even without attaching the lenticular lens 520 as a film on the display 160, an electro-active lenticular that changes the refractive index by applying voltage to molecules of electronic liquid crystal may be applied.

FIG. 5B is a view illustrating a structure for providing 3D content of an electronic device according to an embodiment of the disclosure. For example, FIG. 5B illustrates a structure including a parallax barrier.

Referring to FIG. 5B, the electronic device may alternately arrange a left-eye image 510 and a right-eye image 511 to display on the display 160.

According to an embodiment, the electronic device may include a parallax barrier 530 on the display 160. For example, the parallax barrier 530 is one of glass-free, glassless, naked eye stereoscopic 3D technologies, and may be a method of creating parallax between the left eye and right eye by placing barriers 530 in front of the display 160. For example, the barriers 530 may be disposed with the same period as the image.

According to an embodiment, when viewed from a predetermined distance, the left-eye image is visible to the left eye and the right-eye image is visible to the right eye through open slits between barriers, and images for the other eye may be blocked by the barriers 530.

According to an embodiment, the electronic device may provide 3D content even when not viewed from the front by generating and displaying the left-eye image and the right-eye image through tracking the user's pupils.

FIG. 6A is a view illustrating an operation of displaying 3D content based on a scroll input on a screen including 2D content of an electronic device according to an embodiment of the disclosure.

Referring to FIG. 6A, an electronic device (e.g., the electronic device 101 of FIG. 1 or the processor 120 of FIG. 1) may display a screen 610 including a plurality of 2D contents 611, 612, 613. For example, the screen 610 may be a home screen or an application execution screen.

According to an embodiment, when a scroll input 61 is received through the screen 610, the electronic device may change to a 3D mode and sequentially display 3D content one by one according to the arrangement order.

For example, the electronic device may display a screen 620 including A content 621 as 3D content. The 3D content may be overlaid on other 2D content and may have an increased size.

According to an embodiment, when a scroll input is received while A content 621 is displayed as 3D content, the electronic device may display A content as 2D content again and display B content as 3D content.

As such, when a plurality of 2D contents including depth information are included, the electronic device may sequentially display 3D content.

FIG. 6B is a view illustrating an operation of displaying 3D content of an electronic device according to an embodiment of the disclosure.

Referring to FIG. 6B, the electronic device may display a plurality of 2D contents including depth information as a screen 630, 640, 650 including a plurality of 3D contents.

For example, the electronic device may display a screen 630 with A content > B content > C content having different sizes through size adjustment, with A content, B content, C content at least partially overlapped in order with A content disposed in the topmost layer.

According to an embodiment, the electronic device may display a screen 640 with A content > B content > C content having different sizes through size adjustment, with A content, B content, C content not overlapping.

According to an embodiment, the electronic device may display a screen 650 with A content, B content, C content all having the same size and not overlapping.

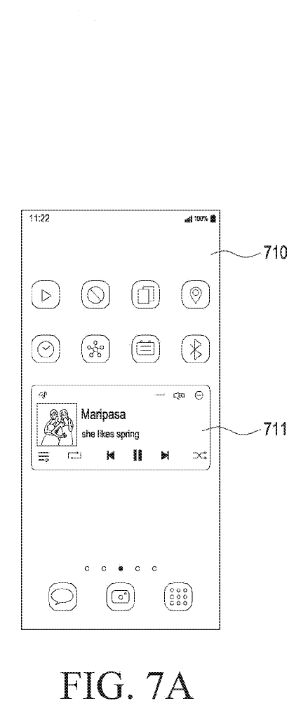

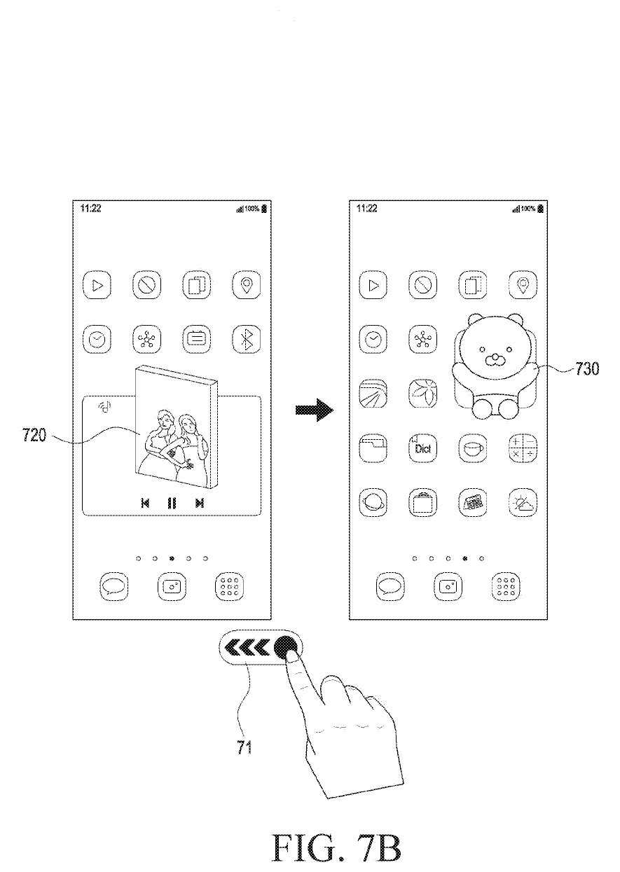

FIG. 7A is a view illustrating a screen including 2D content including depth information of an electronic device according to an embodiment of the disclosure.

Referring to FIG. 7A, an electronic device (e.g., the electronic device 101 of FIG. 1 or the processor 120 of FIG. 1) may display a home screen 710 including a plurality of 2D contents that may or may not include depth information. For example, content 711 including depth information may also be displayed as 2D content on the home screen 710.

FIG. 7B is a view illustrating an operation of displaying 3D content based on a scroll input of an electronic device according to an embodiment of the disclosure.

Referring to FIG. 7B, the electronic device may switch to a 3D mode when 2D content including depth information is included. For example, the electronic device may display 2D content as 3D content 720 based on depth information.

According to an embodiment, in a 3D mode state, the electronic device may identify whether content including depth information is included in a changed screen based on receiving user interaction (e.g., scroll, drag, swipe).

According to an embodiment, when the electronic device moves a page through a drag input 71 on the home screen, if the displayed page includes content including depth information, it may display it as 3D content 730 based on the depth information.

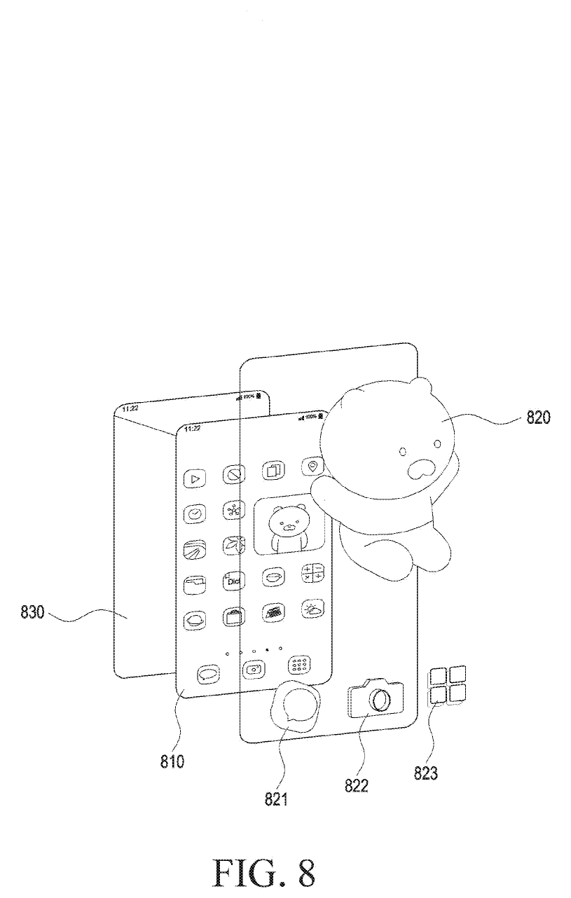

FIG. 8 is a view illustrating a display operation based on content characteristics of an electronic device according to an embodiment of the disclosure.

Referring to FIG. 8, an electronic device (e.g., the electronic device 101 of FIG. 1 or the processor 120 of FIG. 1) may provide different stereoscopic effects based on characteristics of content included in the screen in a 3D mode. For example, among 2D content included in the screen, 2D content including depth information may be displayed as 3D content 820, 821, 822, 823 including a stereoscopic effect (e.g., (+) stereoscopic effect) of protruding from the display based on the depth information.

According to an embodiment, the electronic device may display 2D content not including depth information as 2D content 810 without stereoscopic effect with depth of 0 on the display. According to an embodiment, among 2D content not including depth information, the electronic device may display 2D content including information (e.g., icons, images, or text related to services or functions) with depth of 0 on the display, and 2D content without information (e.g., background screen providing decorative effects) 830 may provide a stereoscopic effect (e.g., (-) stereoscopic effect) as if receding behind the display.

As such, as 3D content has more (+) stereoscopic effect, it may provide realistic stereoscopic effect closer to the user's gaze, and as 3D content has more (-) stereoscopic effect, it moves away from the user's field of view and may help immersion according to distance and blur processing.

FIG. 9A is a view illustrating a 3D content display operation in an application screen of an electronic device according to an embodiment of the disclosure.

Referring to FIG. 9A, an electronic device (e.g., the electronic device 101 of FIG. 1 or the processor 120 of FIG. 1) may display an execution screen 910 of an application. For example, the execution screen 910 of the application may be an execution screen of a messenger application. According to an embodiment, the execution screen 910 of the application may include a plurality of 2D contents (e.g., images or text). For example, the plurality of 2D contents may include 2D content including depth information and 2D content not including depth information.

According to an embodiment, when a scroll input 91 is received, the electronic device may switch to a 3D mode and display 2D content including depth information as 3D content 920 based on the depth information. For example, the electronic device may display 3D content in an area where 2D content including depth information is located or display 3D content 920 in a central area.

According to an embodiment, the electronic device may display 3D content 920 with an increased size and may apply animation effects to the 3D content 920.

According to an embodiment, when the scroll input continues after displaying the 3D content 920, 3D content for 2D content including depth information may be displayed starting from an area not read by the user.

According to an embodiment, the electronic device may display 3D content for 2D content including depth information starting from a section mentioned by the user. According to an embodiment, when a celebration event such as a birthday congratulation message is included, 3D content related to the celebration event may be preferentially displayed.

FIG. 9B is a view illustrating a 3D content display position adjustment operation in an application screen of an electronic device according to an embodiment of the disclosure.

Referring to FIG. 9B, when 3D content 930 and user interaction 92 conflict, the position of the 3D content 931 may be changed to an area that does not conflict with the user interaction 92.

As such, when 3D content is disrupted due to at least partial overlap between the area where 3D content is displayed and the area where user interaction is received, the breaking phenomenon may be prevented by correcting the position of the 3D content.

FIG. 10A is a view illustrating a 3D content display operation in an application screen of an electronic device according to an embodiment of the disclosure.

Referring to FIG. 10A, an electronic device (e.g., the electronic device 101 of FIG. 1 or the processor 120 of FIG. 1) may display an application execution screen 1010. For example, the execution screen 1010 of the application may be an execution screen of a browser application. According to an embodiment, the execution screen 1010 of the application may include a plurality of 2D contents (e.g., images or text). For example, the plurality of 2D contents may include 2D content including depth information and 2D content not including depth information.

According to an embodiment, when a scroll input 1011 is received, the electronic device may switch to a 3D mode and display an indicator 1020 indicating 2D content including depth information. For example, the indicator may be shading such as a shadow or shading applied to the entire image.

According to an embodiment, when a scroll input 1021 is received in a state switched to the 3D mode, the electronic device may display 3D content 1030 based on depth information. For example, the electronic device may display 3D content 1030 in an area where 2D content including depth information is located or display 3D content in a central area.

According to an embodiment, the electronic device may display 3D content 1030 with an increased size and may apply animation effects to the 3D content 1030.

According to an embodiment, 2D content (e.g., text) not including depth information may be maintained as 2D content.

FIG. 10B is a view illustrating a 2D content display position adjustment operation according to 3D content display in an application screen of an electronic device according to an embodiment of the disclosure.

Referring to FIG. 10B, by displaying 3D content 1030 with an increased size, surrounding 2D content (e.g., text) may be obscured. According to an embodiment, the electronic device may change the position of the 2D content 1040 so that surrounding 2D content is not obscured by the size-increased 3D content 1030. For example, the electronic device may move the position of the 2D content 1040 downward.

As such, by moving the position of 2D content so that surrounding 2D content is not obscured by 3D content display, visibility and readability may be ensured.

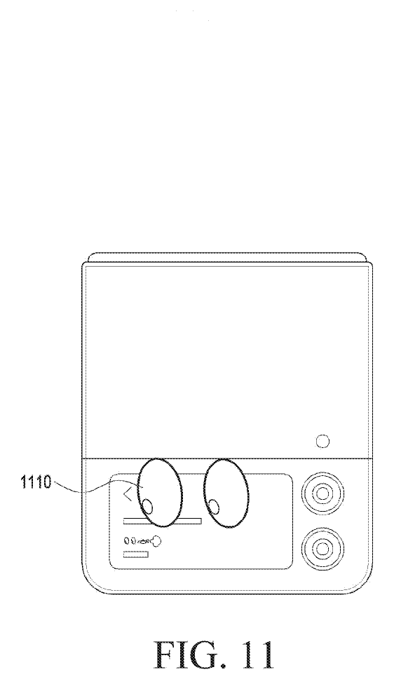

FIG. 11 is a view illustrating a 3D content display operation of a foldable device according to an embodiment of the disclosure.

Referring to FIG. 11, an electronic device (e.g., the electronic device 101 of FIG. 1 or the processor 120 of FIG. 1) may display 3D content in an area where scroll input (or swipe, flick) is possible.

For example, 3D content 1110 according to scroll input may be displayed not only on the front display of the electronic device but also on an edge display, a rear display or cover display when the electronic device is a foldable device, or a rolling area when the electronic device is a rollable device.

According to an embodiment, the area where 3D content 1110 is displayed may be an area where a film such as a lenticular lens or parallax barrier is disposed.

FIG. 12A is a view illustrating an embodiment in which 3D advertisement content is included in an application screen of an electronic device according to an embodiment of the disclosure.

Referring to FIG. 12A, an electronic device (e.g., the electronic device 101 of FIG. 1 or the processor 120 of FIG. 1) may preferentially place a 3D advertisement 1220 in an area 1210 capable of displaying 3D content when user interaction is not received for a set period while 3D content 1211 is displayed in the area 1210 capable of displaying 3D content.

FIG. 12B is a view illustrating an embodiment in which 3D advertisement content is included in an application screen of an electronic device according to an embodiment of the disclosure.

Referring to FIG. 12B, the electronic device may redisplay the 3D content 1211 that was displayed before the 3D advertisement in the area capable of displaying 3D content based on receiving user interaction 1230 (e.g., scroll, drag, swipe, flick) while a 3D advertisement 1220 is displayed in the area capable of displaying 3D content.

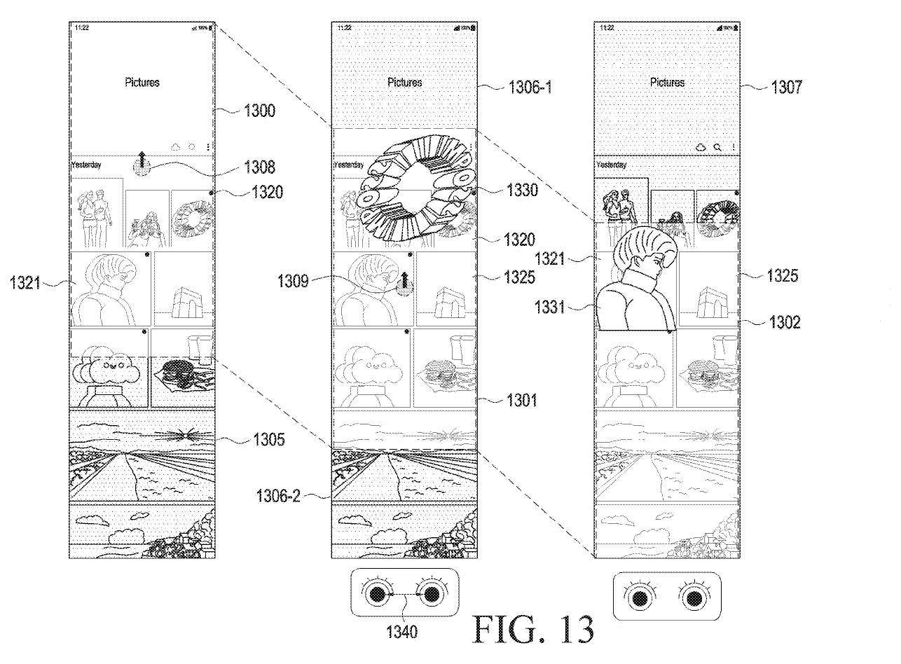

FIG. 13 is a view illustrating an operation of displaying 3D content based on a user input of an electronic device according to an embodiment of the disclosure.

Referring to FIG. 13, an electronic device (e.g., the electronic device 101 of FIG. 1 or the processor 120 of FIG. 1) may display a first area 1300 of an application execution screen on a display (e.g., the display module 160 of FIG. 1). According to an embodiment, the application execution screen may include a first area 1300 displayed on the display and a first invisible area 1305 not displayed on the display. For example, the first area 1300 may include the top of the application execution screen. The first invisible area 1305 may be an area below the first area 1300.

According to an embodiment, the first area 1300 may include a plurality of 2D contents. For example, the plurality of 2D contents may include 2D content not including depth information and 2D content 1320, 1321 corresponding to 3D content. According to an embodiment, the electronic device may display a plurality of 2D contents as one layer.

According to an embodiment, the 2D content 1320, 1321 corresponding to 3D content may include depth information.

According to an embodiment, the 2D content 1320, 1321 corresponding to 3D content may include an indicator (e.g., dot or icon) indicating that it is 3D content.

According to an embodiment, the electronic device may display the 2D content 1320, 1321 corresponding to 3D content with shadow (or shading) processing on included objects.

According to an embodiment, when the electronic device receives a user input (or view switching input) 1308 for changing the area displayed on the display among the application execution screen, it may display a second area 1301 of the application execution screen on the display. For example, the user input may include scroll, swipe, pinch zoom, and/or gaze input.

According to an embodiment, the second area 1301 may be an area that partially overlaps the first area 1300 and has moved downward in the application execution screen. According to an embodiment, a second invisible area 1306-1 may be disposed above the second area 1301, and a third invisible area 1306-2 may be disposed below the second area 1301.

According to an embodiment, when the electronic device identifies that a first 2D content 1320 corresponding to 3D content is disposed in a set area (e.g., an area where a film for displaying 3D content is disposed, a top area, central area, or user-set area among areas where a film for displaying 3D content is disposed), it may display a first 3D content 1330 based on binocular information 1340 (e.g., distance between both eyes) and depth information.

For example, when the electronic device identifies that the first 2D content 1320 corresponding to 3D content is disposed in the set area by a user input while displaying a plurality of 2D contents at a first depth, it may display the first 3D content 1330 at a second depth closer than the first depth. For example, the electronic device may display the first 3D content 1330 as a layer higher than a layer 1325 including a plurality of 2D contents. According to an embodiment, the electronic device may apply blur processing to or darken the brightness of the entire layer 1325 including a plurality of 2D contents.

According to an embodiment, when the first 3D content 1330 is displayed at the second depth, the electronic device may display the first 2D content 1320 corresponding to the first 3D content 1330 at a third depth farther than the first depth. For example, the electronic device may display the first 2D content 1320 corresponding to the first 3D content 1330 as a layer lower than the layer 1325 including a plurality of 2D contents.

According to an embodiment, the depth of at least a partial area of the first 2D content 1320 corresponding to the first 3D content 1330 may be maintained at the first depth and included in the layer 1325 including a plurality of 2D contents. According to an embodiment, blur processing, transparency reduction, or darkening brightness processing applied to the entire layer 1325 including a plurality of 2D contents may be omitted.

According to an embodiment, when the electronic device receives a user input (or view switching input) 1309 for changing the area displayed on the display while displaying the second area 1301 on the display, it may display a third area 1302 of the application execution screen on the display. For example, the user input may include scroll, swipe, pinch zoom, and/or gaze input.

According to an embodiment, the third area 1302 may be an area that partially overlaps the second area 1301 and has moved downward in the application execution screen. According to an embodiment, a fourth invisible area 1307 may be disposed above the third area 1302.

According to an embodiment, as the third area 1302 is displayed on the display, the electronic device may identify that the first 2D content 1320 is outside the set area and a second 2D content 1321 is disposed in the set area.

According to an embodiment, when the electronic device identifies that the second 2D content 1321 is disposed in the set area, it may display a second 3D content 1331 based on binocular information 1304 (e.g., distance between both eyes) and depth information.

For example, the electronic device may display the second 3D content 1331 at a second depth closer than the first depth. For example, the electronic device may display the second 3D content 1331 as a layer higher than the layer 1325 including a plurality of 2D contents. According to an embodiment, the electronic device may apply blur processing to, reduce transparency, or darken the brightness of the entire layer 1325 including a plurality of 2D contents.

According to an embodiment, when the second 3D content 1331 is displayed at the second depth, the electronic device may display the second 2D content 1321 corresponding to the second 3D content 1331 at a third depth farther than the first depth. For example, the electronic device may display the second 2D content 1321 corresponding to the second 3D content 1331 as a layer lower than the layer 1325 including a plurality of 2D contents.

According to an embodiment, the depth of at least a partial area of the second 2D content 1321 corresponding to the second 3D content 1331 may be maintained at the first depth and included in the layer 1325 including a plurality of 2D contents. According to an embodiment, blur processing, transparency reduction, or darkening brightness processing applied to the entire layer 1325 including a plurality of 2D contents may be omitted.

According to an embodiment, when binocular information 1340 changes beyond a predetermined range, the electronic device may update 3D content based on the changed binocular information.

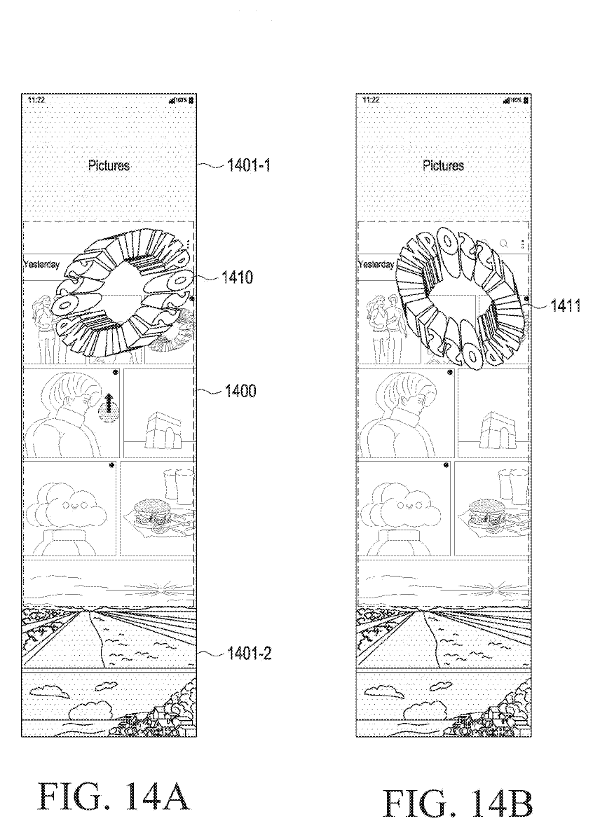

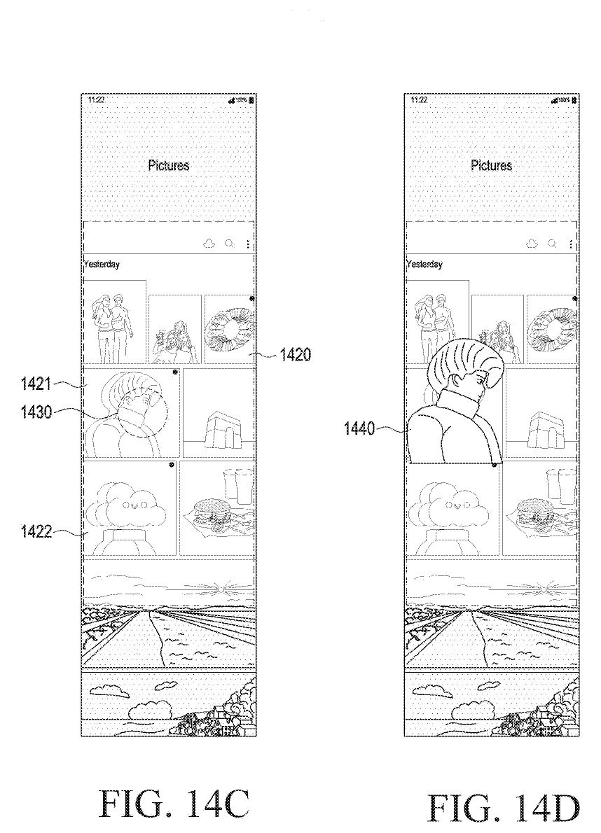

FIG. 14A is a view illustrating a 3D content display operation of an electronic device according to an embodiment of the disclosure.

FIG. 14B is a view illustrating an animation effect display operation of 3D content of an electronic device according to an embodiment of the disclosure.

Referring to FIG. 14A, an electronic device (e.g., the electronic device 101 of FIG. 1 or the processor 120 of FIG. 1) may display a first area 1400 of an application execution screen on a display (e.g., the display module 160 of FIG. 1). According to an embodiment, the application execution screen may include a first area 1400, a first invisible area 1401-1 disposed at the top of the first area 1400, and a second invisible area 1401-2 disposed at the lower surface of the first area 1400.

According to an embodiment, when the electronic device identifies that a first 2D content corresponding to a first 3D content is disposed in a set area based on a user input received while a plurality of 2D contents are displayed, it may display a first 3D content 1410. For example, the electronic device may display the first 3D content 1410 on a layer higher than the plurality of 2D contents.

According to an embodiment, when the first 3D content 1410 includes an animation effect, the electronic device may display a first 3D content 1411 reflecting the animation effect (e.g., rotation) as illustrated in FIG. 14B.

FIG. 14C is a view illustrating an operation of displaying a 2D content screen after displaying an animation effect of 3D content of an electronic device according to an embodiment of the disclosure.

FIG. 14D is a view illustrating a selected 3D content display operation of an electronic device according to an embodiment of the disclosure.

Referring to FIG. 14C, the electronic device may display a screen including a plurality of 2D contents 1420, 1421, 1422 after the animation effect of the first 3D content 1411 ends. For example, the electronic device may display the first 3D content 1411 as a first 2D content 1420 again after the animation effect of the first 3D content 1411 ends.

According to an embodiment, when a user input 1430 selecting a second 2D content 1421 among the plurality of 2D contents 1420, 1421, 1422 is received, the electronic device may display a second 3D content 1440 corresponding to the second 2D content 1421 as illustrated in FIG. 14D. For example, the user input 1430 may include a touch input or gaze input.

According to an embodiment, the electronic device may sequentially display a plurality of 2D contents 1420, 1421, 1422 as 3D content over time. For example, as illustrated in FIG. 14A, after displaying the first 3D content 1410, when a set time passes, the electronic device may change the first 3D content 1410 to the first 2D content 1420 and display a second 3D content 1440 as illustrated in FIG. 14D.

According to an embodiment, an electronic device (e.g., 101 of FIG. 1) may include a display (e.g., 160 of FIG. 1) displaying a left-eye image and a right-eye image, memory (e.g., 130 of FIG. 1), and a processor (e.g., 120 of FIG. 1) electrically connected with the display and the memory.

According to an embodiment, the memory may store instructions that, when executed by the processor, cause the electronic device to control the display to display a left-eye image and a right-eye image of a screen including a plurality of 2D contents including 2D content (e.g., 320, 321 of FIG. 3B) corresponding to 3D content (e.g., 331, 332 of FIGS. 3C and 3D).

According to an embodiment, the memory may store instructions that, when executed by the processor, cause the electronic device to identify that the 2D content corresponding to the 3D content among the plurality of 2D contents is disposed in a set area based on a user input (e.g., 330 of FIGS. 3C and 3D) for controlling the screen.

According to an embodiment, the memory may store instructions that, when executed by the processor, cause the electronic device to control the display to display the 2D content as 3D content.

According to an embodiment, the electronic device may further include a film disposed on at least a partial area of the display to provide 3D content by transmitting the left-eye image and the right-eye image.

According to an embodiment, the film may include at least one of a lenticular lens or a parallax barrier.

According to an embodiment, the electronic device may further include at least one sensor for identifying a position of a user's eyes.

According to an embodiment, the memory may store instructions that, when executed by the processor, cause the electronic device to identify a position of the user's both eyes obtained through the at least one sensor.

According to an embodiment, the memory may store instructions that, when executed by the processor, cause the electronic device to display 2D content not including depth information among the plurality of 2D contents at at least one of the first depth or a second depth farther than the first depth based on the position of the both eyes when the plurality of 2D contents are displayed at a first depth.

According to an embodiment, the memory may store instructions that, when executed by the processor, cause the electronic device to control the display to display the 3D content with an increased size compared to the 2D content.

According to an embodiment, the memory may store instructions that, when executed by the processor, cause the electronic device to control the display to display the size-increased 3D content at a position different from a position of the user input.

According to an embodiment, the memory may store instructions that, when executed by the processor, cause the electronic device to control the display to change a position of 2D content overlapping the size-increased 3D content.

According to an embodiment, the memory may store instructions that, when executed by the processor, cause the electronic device to, based on the 3D content including information about an animation effect, control the display to display the 3D content including the animation effect.

According to an embodiment, the memory may store instructions that, when executed by the processor, cause the electronic device to change the 3D content to the 2D content based on identifying that the 3D content is outside the set area based on a user input received after displaying the 3D content.

According to an embodiment, the memory may store instructions that, when executed by the processor, cause the electronic device to control the display to display a second 2D content as a second 3D content based on identifying that the second 2D content including depth information is disposed in the set area.

According to an embodiment, the memory may store instructions that, when executed by the processor, cause the electronic device to control the display to display each of a plurality of 2D contents including depth information included in the screen as a plurality of 3D contents based on the user input.

According to an embodiment, the memory may store instructions that, when executed by the processor, cause the electronic device to display a 3D advertisement in the set area based on absence of user input for a set period after the 3D content is displayed in the set area.

According to an embodiment, the memory may store instructions that, when executed by the processor, cause the electronic device to control the display to display the 3D content in the set area based on receiving a user input after displaying the 3D advertisement.

According to an embodiment, a control method of an electronic device may include an operation of displaying a left-eye image and a right-eye image of a screen including a plurality of 2D contents including 2D content corresponding to 3D content.

According to an embodiment, the control method of the electronic device may include an operation of identifying that the 2D content corresponding to the 3D content among the plurality of 2D contents is disposed in a set area based on a user input for controlling the screen.

According to an embodiment, the control method of the electronic device may include an operation of displaying the 2D content as 3D content.

According to an embodiment, the operation of displaying as 3D content may display the 3D content through a film disposed on at least a partial area of a display of the electronic device to provide 3D content by transmitting the left-eye image and the right-eye image.

According to an embodiment, the film may include at least one of a lenticular lens or a parallax barrier.

According to an embodiment, the control method of the electronic device may further include an operation of identifying a position of the user's both eyes obtained through at least one sensor of the electronic device.

According to an embodiment, the control method of the electronic device may further include an operation of displaying 2D content not including depth information among the plurality of 2D contents at at least one of the first depth or a second depth farther than the first depth based on the position of the both eyes when the plurality of 2D contents are displayed at a first depth.

According to an embodiment, the operation of displaying as 3D content may display the 3D content with an increased size compared to the 2D content.

According to an embodiment, the operation of displaying as 3D content may display the size-increased 3D content at a position different from a position of the user input.

According to an embodiment, it may further include an operation of changing a position of 2D content overlapping the size-increased 3D content.

According to an embodiment, the operation of displaying as 3D content may display the 3D content including an animation effect based on the 3D content including information about the animation effect.

According to an embodiment, the control method of the electronic device may further include an operation of changing the 3D content to the 2D content based on identifying that the 3D content is outside the set area based on a user input received after displaying the 3D content.

According to an embodiment, the control method of the electronic device may further include an operation of displaying a second 2D content as a second 3D content based on identifying that the second 2D content including depth information is disposed in the set area.

According to an embodiment, the operation of displaying as 3D content may display each of a plurality of 2D contents including depth information included in the screen as a plurality of 3D contents based on the scroll input.

According to an embodiment, the control method of the electronic device may further include an operation of displaying a 3D advertisement in the set area based on absence of user input for a set period after the 3D content is displayed in the set area.

According to an embodiment, the control method of the electronic device may further include an operation of displaying the 3D content in the set area based on receiving a user input after displaying the 3D advertisement.

According to an embodiment, in a non-transitory computer-readable recording medium storing one or more programs, the one or more programs may include instructions for an electronic device to control the display to display a left-eye image and a right-eye image of a screen including a plurality of 2D contents.

According to an embodiment, the one or more programs may include instructions for the electronic device to identify a position of the user's both eyes obtained through the at least one sensor.

According to an embodiment, the one or more programs may include instructions for the electronic device to identify that 2D content including depth information among the plurality of 2D contents is disposed in a set area based on a scroll input of the screen.

According to an embodiment, the one or more programs may include instructions for the electronic device to control the display to display the 2D content as 3D content based on the position of the both eyes and the depth information.

According to an embodiment, the electronic device may further include a film disposed on the display to provide 3D content by transmitting the left-eye image and the right-eye image.

According to an embodiment, the film may include at least one of a lenticular lens or a parallax barrier.

According to an embodiment, the film may be disposed on a partial area of the display.

According to an embodiment, the one or more programs may include instructions for the electronic device to control the display to display the 3D content with an increased size compared to the 2D content.

According to an embodiment, the one or more programs may include instructions for the electronic device to control the display to display the size-increased 3D content at a position different from the position of the scroll input.

According to an embodiment, the one or more programs may include instructions for the electronic device to control the display to change a position of 2D content overlapping the size-increased 3D content.

According to an embodiment, the one or more programs may include instructions for the electronic device to control the display to display the 3D content including an animation effect based on the 3D content including information about the animation effect.

According to an embodiment, the one or more programs may include instructions for the electronic device to change the 3D content to the 2D content based on identifying that the 3D content is outside the set area based on a scroll input received after displaying the 3D content.

According to an embodiment, the one or more programs may include instructions for the electronic device to control the display to display a second 2D content as a second 3D content based on identifying that the second 2D content including depth information is disposed in the set area.

According to an embodiment, the one or more programs may include instructions for the electronic device to control the display to display each of a plurality of 2D contents including depth information included in the screen as a plurality of 3D contents based on the scroll input.

According to an embodiment, the one or more programs may include instructions for the electronic device to display a 3D advertisement in the set area based on absence of scroll input for a set period after the 3D content is displayed in the set area.

According to an embodiment, the one or more programs may include instructions for the electronic device to control the display to display the 3D content in the set area based on receiving a scroll input after displaying the 3D advertisement.

According to an embodiment, an electronic device may include at least one sensor for identifying a position of a user's eyes, a display, and at least one processor electrically connected with the at least one sensor and the display.

According to an embodiment, the memory may store instructions that, when executed by the processor, cause the electronic device to control the display to display a screen including a first 2D content and a second 2D content corresponding to 3D content.

According to an embodiment, the memory may store instructions that, when executed by the processor, cause the electronic device to identify that the second 2D content is disposed in a set area of the display based on a user input for controlling the screen.

According to an embodiment, the memory may store instructions that, when executed by the processor, cause the electronic device to display the 3D content as an upper layer of the second 2D content.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. In connection to the description of the drawings, similar reference numerals may be used for similar or related components. It is to be understood that a singular form of a noun corresponding to an item may include one or more of the things, unless the relevant context clearly indicates otherwise. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "1st" and "2nd," or “first” and "second" may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” "coupled to," "connected with," or “connected to” another element (e.g., a second element), it means that the element may be coupled with the other element directly (e.g., wiredly), wirelessly, or via a third element. As used herein, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display configured to display a left-eye image and a right-eye image;
memory, comprising one or more storage media, storing instructions; and
one or more processors electrically connected with the display and the memory,
wherein the instructions, when executed by the one or more processors individually or collectively, cause the electronic device to:
control the display to display a plurality of two-dimensional (2D) contents including content displayable in three-dimensional (3D) through the left-eye image and the right-eye image without parallax,
identify, based on a user input, that the content displayable in 3D among the plurality of 2D contents is disposed within a set area, and
control the display to display the content disposed within the set area in 3D.

2. The electronic device of claim 1, further comprising:
a film disposed on at least a partial area of the display to provide 3D content by transmitting the left-eye image and the right-eye image,
wherein the film includes at least one of a lenticular lens or a parallax barrier.

3. The electronic device of claim 1, further comprising:
at least one sensor for identifying a position of a user's eyes,
wherein the instructions, when executed by the one or more processors individually or collectively, further cause the electronic device to:
identify a position of the user's both eyes obtained through the at least one sensor, and
when the plurality of 2D contents are displayed at a first depth, display 2D content not including depth information among the plurality of 2D contents at least one of the first depth or a second depth farther than the first depth, based on the position of the both eyes.

4. The electronic device of claim 2, wherein the instructions, when executed by the one or more processors individually or collectively, further cause the electronic device to control the display to display the 3D content with an increased size compared to the 2D content.

5. The electronic device of claim 4, wherein the instructions, when executed by the one or more processors individually or collectively, further cause the electronic device to control the display to display the size-increased 3D content at a position different from a position of the user input.

6. The electronic device of claim 4, wherein the memory stores instructions that, when executed by the one or more processors, cause the electronic device to control the display to change a position of 2D content overlapping the size-increased 3D content.

7. The electronic device of claim 2, wherein the instructions, when executed by the one or more processors individually or collectively, further cause the electronic device to, based on the 3D content including information about an animation effect, control the display to display the 3D content including the animation effect.

8. The electronic device of claim 2, wherein the instructions, when executed by the one or more processors individually or collectively, further cause the electronic device to:
change the 3D content to the 2D content based on identifying that the 3D content is outside the set area based on a user input received after displaying the 3D content; and
control the display to display a second 2D content as a second 3D content based on identifying that the second 2D content including depth information is disposed in the set area.

9. The electronic device of claim 1, wherein the instructions, when executed by the one or more processors individually or collectively, further cause the electronic device to control the display to display a plurality of 2D contents including depth information as a plurality of 3D contents respectively, based on the user input.

10. The electronic device of claim 2, wherein the instructions, when executed by the one or more processors individually or collectively, further cause the electronic device to:
display a 3D advertisement in the set area based on absence of user input for a set period after the 3D content is displayed in the set area; and
control the display to display the 3D content in the set area based on receiving a user input after displaying the 3D advertisement.

11. A control method of an electronic device comprising:
displaying a plurality of two-dimensional (2D) contents including corresponding content displayable in three-dimensional (3D) through a left-eye image and a right-eye image without parallax;
identifying, based on a user input, that the content displayable in 3D among the plurality of 2D contents is disposed within a set area; and
displaying the content disposed within the set area in 3D.

12. The control method of claim 11,
wherein the displaying in 3D displays 3D content through a film disposed on at least a partial area of a display of the electronic device to provide 3D content by transmitting the left-eye image and the right-eye image, and
wherein the film includes at least one of a lenticular lens or a parallax barrier.

13. The control method of claim 11, further comprising:
identifying a position of the user's both eyes obtained through at least one sensor of the electronic device; and
when the plurality of 2D contents are displayed at a first depth, displaying 2D content not including depth information among the plurality of 2D contents at at least one of the first depth or a second depth farther than the first depth based on the position of the both eyes.

14. The control method of claim 12, wherein the displaying in 3D displays the 3D content with an increased size compared to the 2D content.

15. The control method of claim 14, wherein the displaying in 3D displays the size-increased 3D content at a position different from a position of the user input.

16. The control method of claim 14, further comprising changing a position of 2D content overlapping the size-increased 3D content.

17. The control method of claim 12, further comprising based on the 3D content including information about an animation effect, displaying the 3D content including the animation effect.

18. The control method of claim 12, further comprising:
changing the 3D content to the 2D content based on identifying that the 3D content is outside the set area based on a user input received after displaying the 3D content; and
displaying a second 2D content as a second 3D content based on identifying that the second 2D content including depth information is disposed in the set area.

19. One or more non-transitory computer-readable storage media storing one or more computer programs including computer-executable instructions that, when executed by one or more processors of an electronic device individually or collectively, cause the electronic device to perform operations, the operations comprising:
displaying a plurality of two-dimensional (2D) contents including corresponding content displayable in three-dimensional (3D) through a left-eye image and a right-eye image without parallax;
identifying, based on a user input, that the content displayable in 3D among the plurality of 2D contents is disposed within a set area; and
displaying the content disposed within the set area in 3D.

20. The one or more non-transitory computer-readable storage media of claim 19, the operations further comprising:
wherein the displaying in 3D displays 3D content through a film disposed on at least a partial area of a display of the electronic device to provide 3D content by transmitting the left-eye image and the right-eye image, and
wherein the film includes at least one of a lenticular lens or a parallax barrier.
